(19) United States
(12) Patent Application Publication
(10) Pub. No.: US 2010/0260948 A1
(43) Pub. Date: Oct. 14, 2010

(54) DECORATION BODY

(76) Inventor: Yumiko Nakayashi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/743,982

(22) PCT Filed: Aug. 30, 2008
(86) PCT No.: PCT/JP2008/065605

§ 371 Date: Jun. 16, 2010

(30) Foreign Application Priority Data
Nov. 29, 2007 (JP) 2007-009197

(51) Int. Cl. A41G 1/00; B32B 3/10; A47G 33/04

(52) U.S. Cl. 428/10; 428/137; 428/7; 428/23; 428/34.4

(57) ABSTRACT

A decoration body for various objects such as wreaths, Christmas trees, bouquets, and feng shui goods, which are rationally and beautifully decorated with small decoration members such as natural stones or glass sculptures is provided. The decoration body includes: a plurality of smallest base members bundled to form one intermediate base member, each of the smallest base members being composed by providing a small hole in a small decoration member such as a natural stone or a glass sculpture and causing a wire to penetrate through the small hole; a plurality of the intermediate base member further bundled to form one base decoration body; and a plurality of the base decoration body being disposed.

### TECHNICAL FIELD

The present invention relates to the technical field of decoration bodies used as wreaths, Christmas trees, bouquets, feng shui-related products, and other various objects for decoration.

### BACKGROUND ART

Recently, objects such as wreaths, Christmas trees, bouquets, and feng shui goods are more frequently used in households and various shops.

For example, Utility Model Gazette No. 3072724 according to below described Document 1 discloses an art object of a flower in which a light such as a miniature light bulb or optical fiber is attached to the main body of the art object of the artificial flower, and the flower center or part of the main body emits light. Patent Document 1: Utility Model Gazette No. 3072724

### DISCLOSURE OF INVENTION

Problem to be Solved by the Invention

The art object of above described Document 1 can be enjoyed as more luxury ornamental lighting in dark space by attaching the light such as the miniature light bulb or the optical fiber to the main body of the art object and emitting light from the flower center or part of the main body.

However, such art object of a flower takes production cost, and, moreover, the effect by the light is not satisfactory. Objects such as wreaths, Christmas trees, bouquets, and feng shui which are beautifully decorated with small decoration members of natural stones or glass sculptures regardless of day or night have not been provided.

Therefore, a problem to be solved by the present invention is to provide decoration bodies for various objects such as wreaths, Christmas trees, bouquets, and feng shui goods which are rationally and beautifully decorated with small decoration members of natural stones or glass sculptures.

### MEANS FOR SOLVING THE PROBLEMS

As a means for solving the above described problem, a decoration body of the invention according to claim 1 is formed as an object composed of: a plurality of smallest base members 5 bundled to form one intermediate base member 6, each of the smallest base members 5 being composed by providing a small hole 2 in a small decoration member 1 such as a natural stone or a glass sculpture and causing a wire 3 to penetrate through the small hole 2; a plurality of the intermediate base member 6 further bundled to form one base decoration body 7; and a plurality of the base decoration body 7 being disposed.

A decoration body of the invention according to claim 2 is formed as a wreath A composed of: a plurality of smallest base members 5 bundled to form one intermediate base member 6, each of the smallest base members 5 being composed by providing a small hole 2 in a small decoration member 1 such as a natural stone or a glass sculpture and causing a wire 3 to penetrate through the small hole 2; a plurality of the intermediate base member 6 further bundled to form one base decoration body 7; and a plurality of the base decoration body 7 being disposed like a ring.

A decoration body of the invention according to claim 3 is formed as a Christmas tree B composed of: a plurality of smallest base members 5 bundled to form one intermediate base member 6, each of the smallest base members 5 being composed by providing a small hole 2 in a small decoration member 1 such as a natural stone or a glass sculpture and causing a wire 3 to penetrate through the small hole 2; a plurality of the intermediate base member 6 further bundled to form one base decoration body 7; and a plurality of the base decoration body 7 being disposed conically and housed in a container 9.

A decoration body of the invention according to claim 4 is formed as a bouquet C composed of: a plurality of smallest base members 5 bundled to form one intermediate base member 6, each of the smallest base members 5 being composed by providing a small hole 2 in a small decoration member 1 such as a natural stone or a glass sculpture and causing a wire 3 to penetrate through the small hole 2; a plurality of the intermediate base member 6 further bundled to form one base decoration body 7; and a plurality of the base decoration body 7 being disposed in a mountain-like shape.

A decoration body of the invention according to claim 5 is a decoration body being formed as a feng shui object composed of: a plurality of smallest base members 5 bundled to form one intermediate base member 6, each of the smallest base members 5 being composed by providing a small hole 2 in a small decoration member 1 such as a natural stone or a glass sculpture and causing a wire 3 to penetrate through the small hole 2; a plurality of the intermediate base member 6 further bundled to form one base decoration body 7; and a plurality of the base decoration body 7 being disposed and housed in a container.

A decoration body of the invention according to claim 6 wherein a protecting bead 4 is penetrated through by the wire 3 of the smallest base member 5, and the wire 3 is folded back and wound around in the state in which the protecting bead 4 is disposed at a lower end.

A decoration body of the invention according to claim 7 wherein the intermediate base member 6 is formed by mutually winding the wires 3 . . . of the plurality of smallest base members 5 . . . , and the base decoration body 7 is formed by bundling the wires 3 . . . of the plurality of intermediate base members 6 . . . and winding a metal fiber 8 around the outer peripheries of the wires 3.

A decoration body of the invention according to claim 8 wherein the base decoration body 7 is equipped with a light emitting element such as a LED.

### EFFECTS OF THE INVENTION

In the decoration bodies of the present invention according to claims 1 to 8, a plurality of smallest base members are bundled to form one intermediate base member, wherein each of the smallest base members is composed by providing a small hole in a small decoration member such as a natural stone or a glass sculpture and causing a wire to penetrate through the small hole; a plurality of the intermediate base member are further bundled to form one base decoration body; and a plurality of the base decoration body are disposed. Therefore, various objects such as wreaths, Christmas trees, bouquets, and feng shui goods, which are rationally and beautifully decorated, are realized, and excellent effects of easily producing a flamboyant and gorgeous atmosphere in a room are exerted.

### BRIEF DESCRIPTION OF DRAWINGS

FIG. 1 is an overall view showing an intermediate base member of a decoration body;

FIG. 2 is an overall view showing a base decoration body of the decoration body;

FIG. 3 is a front view showing a wreath formed of the base decoration bodies;

FIG. 4 is a front view showing a Christmas tree formed of the base decoration bodies;

FIG. 5 is a front view showing a bouquet formed of the base decoration bodies;

FIG. 6 is a front view showing a different object;

FIG. 7 is a front view showing a cross-style object;

FIG. 8 is an overall view showing a decoration member of the decoration body;

FIG. 9 is an overall view showing the base decoration body of the decoration body;

FIG. 10 is an overall view showing the intermediate base member of the decoration body; and

FIG. 11 is an overall view showing the base decoration body of the decoration body from a lower side.

### DESCRIPTION OF REFERENCE NUMERALS

A WREATH

B CHRISTMAS TREE

C BOUQUET

1 DECORATION MEMBER

2 SMALL HOLE

3 WIRE

4 PROTECTING BEAD

5 SMALLEST BASE MEMBER

6 INTERMEDIATE BASE MEMBER

7 BASS DECORATION BODY

8 METAL FIBER

9 CONTAINER

### BEST MODES FOR CARRYING OUT THE INVENTION

Suitable embodiments of a decoration body according to the present invention will be explained below in accordance with drawings. Since the embodiments related to the invention of present claims 1 to 8 are common, the embodiments will be collectively explained below.

The decoration body of the present embodiment is formed of intermediate base members 6, each of which is an assembly of smallest base members 5, and base decoration bodies 7, each of which is an assembly of the intermediate base members 6.

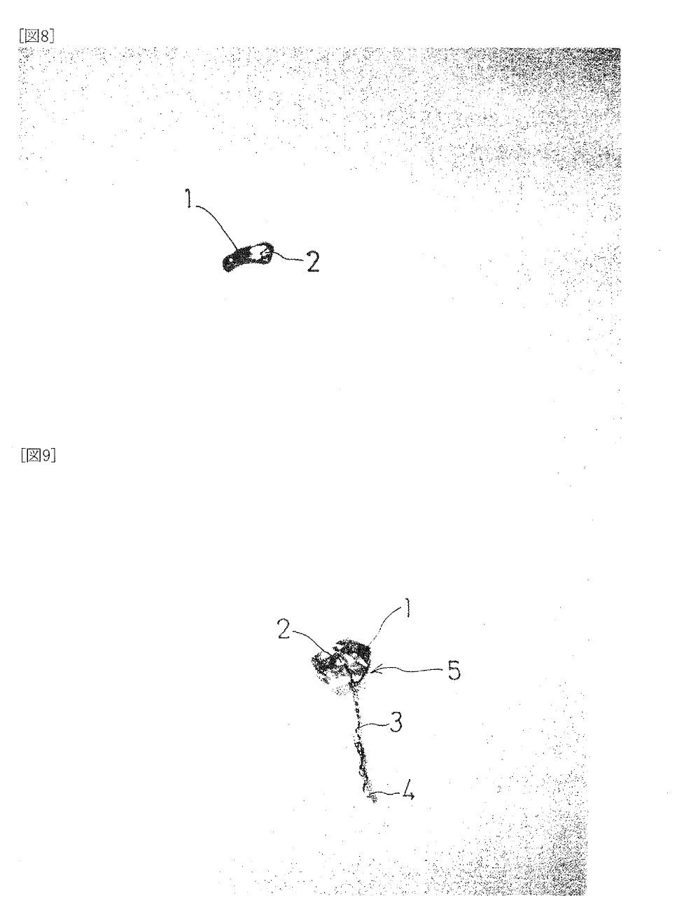

In the smallest base member 5, as shown in FIG. 8, a small hole 2 is provided through a small decoration member 1 of a natural stone or a glass sculpture. Other than that, a button, a ribbon, a cloth, a message plate, a chain, a bead, etc. can be suitably used as the decoration member 1. The small hole 2 of the decoration member 1 is provided so as to penetrate through the decoration member 1 per se. A wire 3 of a thin wire material penetrates through the small hole 2 and twisted, thereby configuring the wire 3 so that the wire 3 is not separated from the decoration member 1 (FIG. 9).

Protecting beads 4 for avoiding damage are provided at the lower end of the smallest base member 5. The protecting beads 4 are penetrated through by the wire 3, and the wire 3 is folded back and wound around in the state in which the protecting beads 4 are disposed at the lower end.

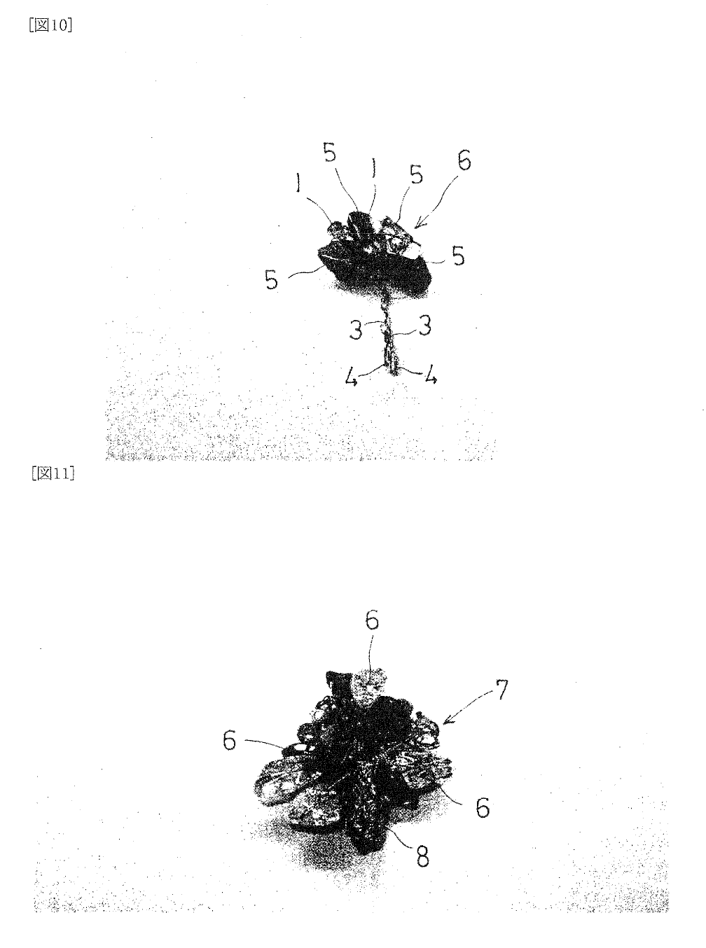

Next, the intermediate base member 6 as shown in FIG. 10 is formed. Regarding the intermediate base member 6, each intermediate base member 6 is formed by bundling 12 to 14 smallest base members 5 described above. However, the number of the smallest base members 5 is not limited thereto.

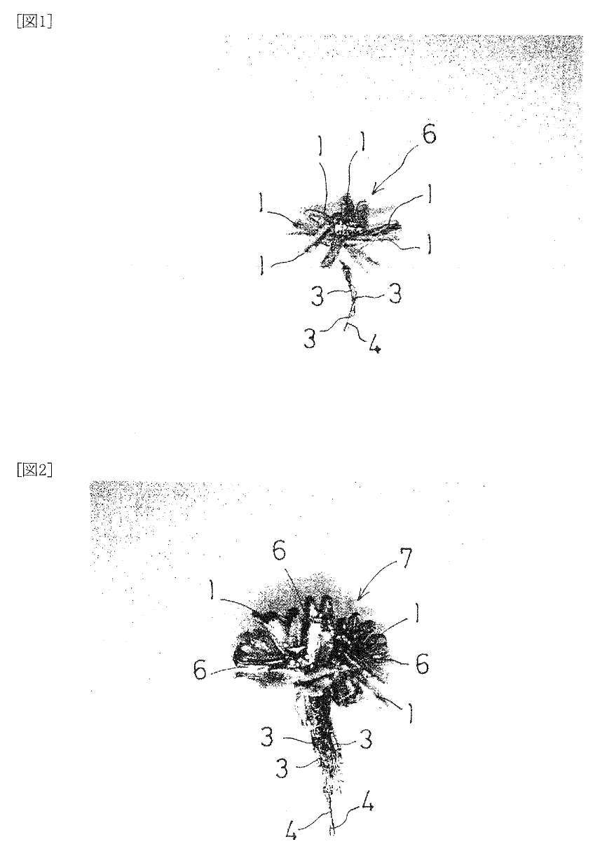

The intermediate base member 6 shown in FIG. 1 is formed like flower petals.

As shown in FIG. 11, three intermediate base members 6 described above are further bundled, thereby forming one base decoration body 7. However, the number of the intermediate base members 6 is not limited to three, and an arbitrary number of them are bundled and subjected to use. When a plurality of the base decoration bodies 7 are disposed in a desired shape, they are completed as an object. Specific examples of the object include wreaths, Christmas trees, bouquets, and fang shui goods, which will be described. later.

The plurality of wires 3 . . . of the base decoration body 7 are formed by mutually twisting and winding the wires 3 . . . of the plurality of smallest base members 5 in the intermediate base members 6 and further bundling the wires 3 . . . of the plurality of intermediate base members 6 . . . .

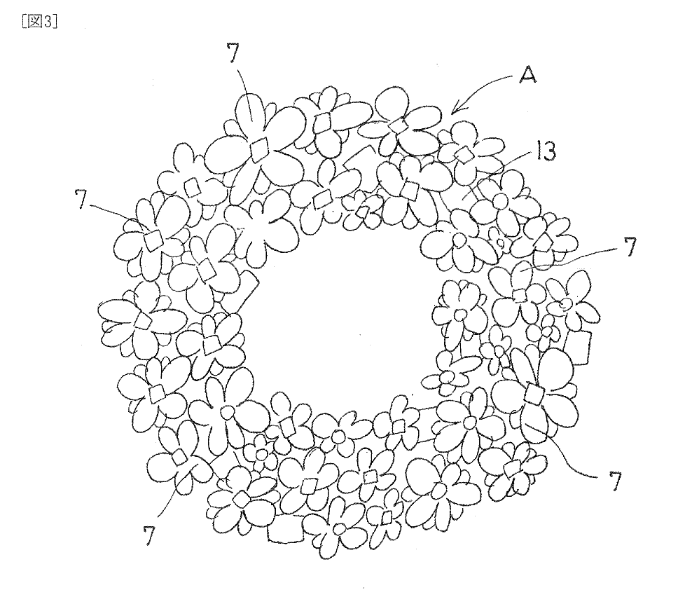

The base decoration body 7 shown in FIG. 2 is formed as a big flower by bundling three intermediate base members 6, which are like flower petals (FIG. 1).

Metal fibers 8 (free metallico) are wound around the outer peripheries of the plurality of bundled wires 3 . . . of the intermediate base members 6 in the above described manner so as to facilitate handling. However, in a mode which can be employed, paper, a ribbon, or the like is used to be wound around the plurality of wires 3 . . . , instead of the above described metal fibers 8.

Moreover, an embodiment in which the thus-formed base decoration body 7 is equipped with a light emitting element such as a LED, which is not illustrated, can be also employed, wherein the effect. of decoration is further enhanced.

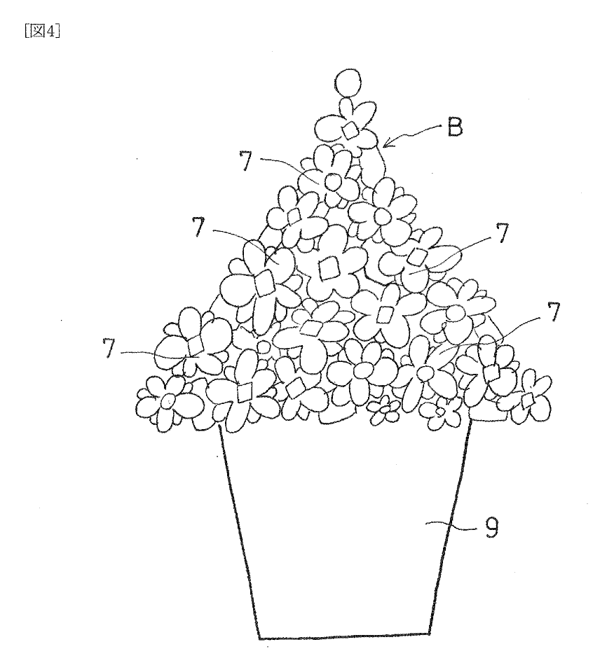

FIG. 3 shows a wreath composed of the decoration body of the present embodiment.

The wreath A is formed by disposing a plurality of above described base decoration bodies 7 like a ring. The wreath is suitably implemented by attaching the plurality of base decoration bodies 7 to an annular ring body 13.

FIG. 4 shows a Christmas tree composed of the decoration body of the present embodiment.

The Christmas tree B is formed by disposing the plurality of base decoration bodies 7 . . . in a conical shape such as a circular cone, which has a pointed upper part, and housing the wires 3 . . . , which are bundled in the lower side, in a container 9 of ceramic or the like.

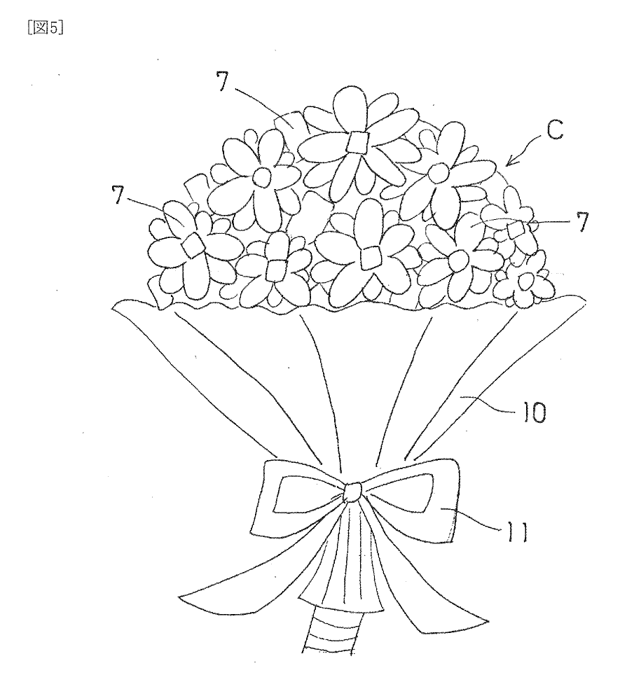

FIG. 5 shows a bouquet composed of the decoration body of the present embodiment.

The bouquet C is formed by disposing the plurality of base decoration bodies 7 . . . in a mountain-like shape and wrapping the outer peripheries of the wires 3, which are bundled in the lower side, by using wrapping paper 10 and a ribbon 11.

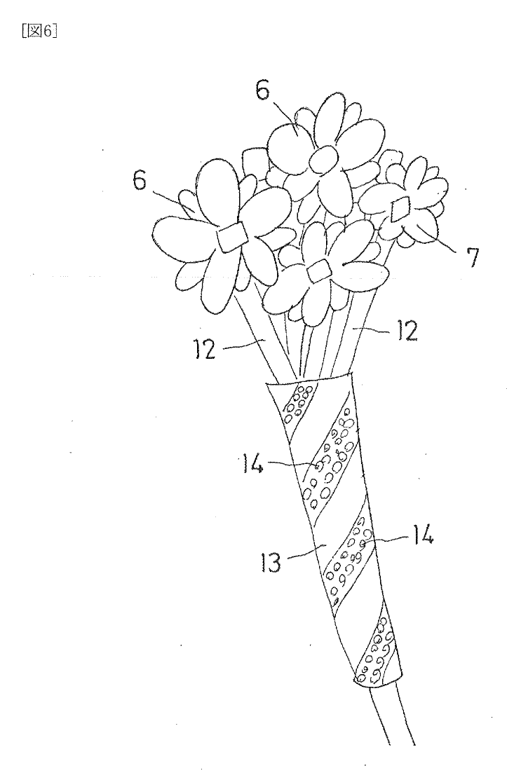

FIG. 6 shows an object formed by extending the base end (wire) parts of the plurality of intermediate base members 6 by stick-like rods 12 and wrapping the outer peripheries of the long rods 12 . . . by a wrapping such as paper, a cloth, or a ribbon. When the object is implemented so as to have beads 14 on the surface of the wrapping like the illustrated example, the object can he more gorgeously displayed.

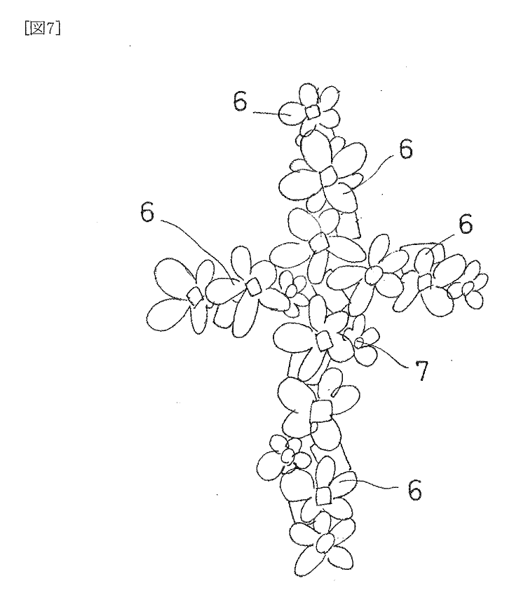

FIG. 7 shows an embodiment in which the plurality of intermediate base members 6 or the base decoration bodies 7 are formed into a cross-like shape. The decoration body can be formed to have a desired shape/pattern in this manner.

Furthermore, a mode which is implemented as an object of feng shui in which the plurality of base decoration bodies 7 . . . having a desired shape are housed in a container is also suitably employed (illustration is omitted).

### INDUSTRIAL APPLICABILITY

Various objects such as wreaths, Christmas trees, bouquets, and feng shui goods, which are rationally and beautifully decorated, can be realized, and the atmosphere in a room can be flamboyantly and gorgeously produced easily.

1. A decoration body being formed as an object comprising:
a plurality of smallest base members bundled to form one intermediate base member, each of the smallest base members being composed by providing a small hole in a small decoration member such as a natural stone or a glass sculpture and causing a wire to penetrate through the small hole;
a plurality of the intermediate base member further bundled to form one base decoration body; and
a plurality of the base decoration body being disposed.

2. A decoration body being formed as a wreath comprising:
a plurality of smallest base members bundled to form one intermediate base member, each of the smallest base members being composed by providing a small hole in a small decoration member such as a natural stone or a glass sculpture and causing a wire to penetrate through the small hole;
a plurality of the intermediate base member further bundled to form one base decoration body; and
a plurality of the base decoration body being disposed like a ring.

3. A decoration body being formed as a Christmas tree comprising:
a plurality of smallest base members bundled to form one intermediate base member, each of the smallest base members being composed by providing a small hole in a small decoration member such as a natural stone or a glass sculpture and causing a wire to penetrate through the small hole;
a plurality of the intermediate base member further bundled to form one base decoration body; and
a plurality of the base decoration body being disposed conically and housed in a container.

4. A decoration body being formed as a bouquet comprising:
a plurality of smallest base members bundled to form one intermediate base member, each of the smallest base members being composed by providing a small hole in a small decoration member such as a natural stone or a glass sculpture and causing a wire to penetrate through the small hole;
a plurality of the intermediate base member further bundled to form one base decoration body; and
a plurality of the base decoration body being disposed in a mountain-like shape.

5. A decoration body being formed as a feng shui object comprising:
a plurality of smallest base members bundled to form one intermediate base member, each of the smallest base members being composed by providing a small hole in a small decoration member such as a natural stone or a glass sculpture and causing a wire to penetrate through the small hole;
a plurality of the intermediate base member further bundled to form one base decoration body; and
a plurality of the base decoration body being disposed and housed in a container.

6. The decoration body according to claim 1, wherein a protecting bead is penetrated through by the wire of the smallest base member, and the wire is folded back and wound around in the state in which the protecting bead is disposed at a lower end.

7. The decoration body according to claim 1, wherein the intermediate base member is formed by mutually winding the wires of the plurality of smallest base members, and the base decoration body is formed by bundling the wires of the plurality of intermediate base members and winding a metal fiber around the outer peripheries of the wires.

8. The decoration body according to claim 1, wherein the base decoration body is equipped with a light emitting element such as a LED.

9. The decoration body according to claim 2, wherein a protecting bead is penetrated through by the wire of the smallest base member, and the wire is folded back and wound around in the state in which the protecting bead is disposed at a lower end.

10. The decoration body according to claim 3, wherein a protecting bead is penetrated through by the wire of the smallest base member, and the wire is folded back and wound around in the state in which the protecting bead is disposed at a lower end.

11. The decoration body according to claim 4, wherein a protecting bead is penetrated through by the wire of the smallest base member, and the wire is folded back and wound around in the state in which the protecting bead is disposed at a lower end.

12. The decoration body according to claim 5, wherein a protecting bead is penetrated through by the wire of the smallest base member, and the wire is folded back and wound around in the state in which the protecting bead is disposed at a lower end.

13. The decoration body according to claim 2, wherein the intermediate base member is formed by mutually winding the wires of the plurality of smallest base members, and the base decoration body is formed by bundling the wires of the plurality of intermediate base members and winding a metal fiber around the outer peripheries of the wires.

14. The decoration body according to claim 3, wherein the intermediate base member is formed by mutually winding the wires of the plurality of smallest base members, and the base decoration body is formed by bundling the wires of the plurality of intermediate base members and winding a metal fiber around the outer peripheries of the wires.

15. The decoration body according to claim 4, wherein the intermediate base member is formed by mutually winding the wires of the plurality of smallest base members, and the base decoration body is formed by bundling the wires of the plurality of intermediate base members and winding a metal fiber around the outer peripheries of the wires.

16. The decoration body according to claim 5, wherein the intermediate base member is formed by mutually winding the wires of the plurality of smallest base members, and the base decoration body is formed by bundling the wires of the plurality of intermediate base members and winding a metal fiber around the outer peripheries of the wires.

17. The decoration body according to claim 6, wherein the intermediate base member is formed by mutually winding the wires of the plurality of smallest base members, and the base decoration body is formed by bundling the wires of the plurality of intermediate base members and winding a metal fiber around the outer peripheries of the wires.

18. The decoration body according to claim 2, wherein the base decoration body is equipped with a light emitting element such as a LED.

19. The decoration body according to claim 3, wherein the base decoration body is equipped with a light emitting element such as a LED.

20. The decoration body according to claim 4, wherein the base decoration body is equipped with a light emitting element such as a LED.

21. The decoration body according to claim 5, wherein the base decoration body is equipped with a light emitting element such as a LED.

22. The decoration body according to claim 6, wherein the base decoration body is equipped with a light emitting element such as a LED.

23. The decoration body according to claim 7, wherein the base decoration body is equipped with a light emitting element such as a LED.
